(19) United States
(12) Patent Application Publication
(10) Pub. No.: US 2026/0371199 A1
(43) Pub. Date: Nov. 19, 2026

(54) APPARATUS AND METHOD FOR SUPPORTING INTER-SYSTEM MOBILITY IN WIRELESS COMMUNICATION SYSTEM

(71) Applicant: LG ELECTRONICS INC., Seoul (KR)

(72) Inventors: Myungjune YOUN, Seoul (KR); Laeyoung KIM, Seoul (KR); Seokjung KIM, Seoul (KR)

(73) Assignee: LG ELECTRONICS INC., Seoul (KR)

(21) Appl. No.: 19/142,805

(22) PCT Filed: Dec. 10, 2024
(86) PCT No.: PCT/KR2024/020208

§ 371 Date: Jun. 24, 2025

Related U.S. Application Data
(60) Provisional application No. 63/619,739, filed on Jan. 11, 2024.
(60) Provisional application No. 63/553,146, filed on Feb. 14, 2024.

(51) Int. Cl. H04W 36/14

(52) U.S. Cl. CPC H04W 36/14

(57) ABSTRACT

The present disclosure is for supporting inter-system mobility in a wireless communication system, and a method performed by a first network node of a first system comprises: receiving a handover required message for a terminal from a source base station, and transmitting, by the first network node, a forward relocation request message to a second network node of a second system based on the handover required message, wherein the forward relocation request message may include at least one of second group identification information related to access of the target cell, or information informing whether the terminal belongs to the second group.

### CROSS-REFERENCE TO RELATED APPLICATION(S)

This application is the National Stage filing under 35 U.S.C. 371 of International Application No. PCT/KR2024/020208, filed on Dec. 10, 2024, which claims the benefit of U.S. Provisional Application No(s). 63/619,739, filed on Jan. 11, 2024, and 63/553,146, filed on Feb. 14, 2024, the contents of which are all incorporated by reference herein in their entirety.

### TECHNICAL FIELD

The following description relates to a wireless communication system, and more particularly to an apparatus and method for supporting inter-system mobility in a wireless communication system.

### BACKGROUND

Wireless access systems are being widely deployed to provide various types of communication services such as voice and data. Generally, a wireless access system is a multiple access system that can support communication with multiple users by sharing available system resources (bandwidth, transmission power, etc.). Examples of multiple access systems include Code Division Multiple Access (CDMA) systems, Frequency Division Multiple Access (FDMA) systems, Time Division Multiple Access (TDMA) systems, Orthogonal Frequency Division Multiple Access (OFDMA) systems, Single Carrier Frequency Division Multiple Access (SC-FDMA) systems, and the like.

In particular, as many communication devices require large communication capacity, enhanced Mobile Broadband (eMBB) communication technology that is improved compared to existing Radio Access Technology (RAT) has been proposed. In addition, communication systems considering not only massive Machine Type Communications (mMTC) that connects multiple devices and objects to provide various services anytime and anywhere, but also reliability and latency sensitive services/User Equipment (UE) have been proposed. Various technical configurations for this purpose are being proposed.

### SUMMARY

The present disclosure relates to an apparatus and method for supporting inter-system mobility in a wireless communication system.

The present disclosure relates to an apparatus and method for supporting interworking between a Closed Access Group (CAG) cell and a Closed Subscriber Group (CSG) cell in a wireless communication system.

The present disclosure relates to an apparatus and method for pre-configuring information related to CSG in an AMF for interworking between a CAG cell and a CSG cell in a wireless communication system.

The present disclosure relates to an apparatus and method for supporting a handover from 5GS to EPS based on information related to CSG configured in an AMF in a wireless communication system.

The present disclosure relates to an apparatus and method for determining whether a handover target cell of a UE is a CSG cell based on information related to CSG configured in an AMF in a wireless communication system.

The present disclosure relates to an apparatus and method for an AMF to transmit CSG ID and CSG membership indication information of a target cell to an MME in a wireless communication system.

The present disclosure relates to an apparatus and method for supporting a handover from 5GS to EPS using information related to CSG obtained based on Automatic Neighbor cell Relation (ANR) in a wireless communication system.

The present disclosure relates to an apparatus and method for supporting a handover from 5GS to EPS using information related to CSG obtained based on configuration transfer signaling in a wireless communication system.

The present disclosure relates to an apparatus and method for supporting a handover from EPS to 5GS using an allowed CAG list in a wireless communication system.

The present disclosure relates to an apparatus and method for obtaining subscriber information of a UE to support a handover from EPS to 5GS in a wireless communication system.

The technical objectives to be achieved by the present disclosure are not limited to the matters mentioned above, and other technical problems not mentioned may be considered by those skilled in the art to which the technical configuration of the present disclosure is applied from the embodiments of the present disclosure to be described below.

As an example of the present disclosure, a method includes receiving, by a first network node of a first system, a handover required message for a UE from a source base station, and transmitting, by the first network node, a forward relocation request message to a second network node of a second system based on the handover required message, wherein the forward relocation request message may include at least one of second group identification information related to access of the target cell, or information informing whether the UE belongs to the second group.

As an example of the present disclosure, a method includes receiving, by a second network node of a second system, a forward relocation request message from a first network node of a first system, and transmitting, by the second network node of the second system, a handover request message for a UE to a base station of the second system, wherein at least one of the forward relocation request message or the handover request message may include at least one of second group identification information related to access of a handover target cell of the UE, or information informing whether the UE belongs to the second group.

As an example of the present disclosure, a method further includes obtaining, by a first base station of a first system, information related to a second group from a second base station of a second system, and transmitting, by the first base station, a handover required message for a UE to a first network node, wherein the handover required message may include at least one of second group identification information related to access of a handover target cell of the UE, or a cell access mode informing whether the target cell is a hybrid cell.

As an example of the present disclosure, an apparatus includes a transceiver, and a processor connected to the transceiver, wherein the processor controls to receive a handover required message for a UE from a source base station of a first system to which the apparatus belongs, and transmit a forward relocation request message to a second network node of a second system based on the handover required message, wherein the forward relocation request message may include at least one of second group identification information related to access of the target cell, or information informing whether the UE belongs to the second group.

As an example of the present disclosure, an apparatus includes a transceiver, and a processor connected to the transceiver, wherein the processor controls to receive a forward relocation request message from a first network node of a first system, and transmit a handover request message for a UE to a base station of a second system to which the apparatus belongs, wherein at least one of the forward relocation request message or the handover request message may include at least one of second group identification information related to access of a handover target cell of the UE, or information informing whether the UE belongs to the second group.

As an example of the present disclosure, an apparatus includes a transceiver, and a processor connected to the transceiver, wherein the processor controls to obtain information related to a second group from a second base station of a second system, and transmit a handover required message for a UE to a first network node of a first system to which the apparatus belongs, wherein the handover required message may include at least one of second group identification information related to access of a handover target cell of the UE, or a cell access mode informing whether the target cell is a hybrid cell.

As an example of the present disclosure, a communication apparatus includes at least one processor, and at least one memory storing instructions that, based on being executed by the at least one processor, direct operations, wherein the operations include receiving, by a first network node of a first system, a handover required message for a UE from a source base station, and transmitting, by the first network node, a forward relocation request message to a second network node of a second system based on the handover required message, wherein the forward relocation request message may include at least one of second group identification information related to access of the target cell, or information informing whether the UE belongs to the second group.

As an example of the present disclosure, a non-transitory computer-readable medium stores at least one instruction, wherein the at least one instruction executable by a processor controls to receive a handover required message for a UE from a source base station of a first system to which the apparatus belongs, and transmit a forward relocation request message to a second network node of a second system based on the handover required message, wherein the forward relocation request message may include at least one of second group identification information related to access of the target cell, or information informing whether the UE belongs to the second group.

The following effects may be achieved by embodiments based on the present disclosure.

The present disclosure can ensure continuity of service in a wireless communication system.

The effects obtainable from the embodiments of the present disclosure are not limited to the effects mentioned above, and other effects not mentioned can be clearly derived and understood by those skilled in the art to which the technical configuration of the present disclosure is applied from the description of the embodiments of the present disclosure below. That is, unintended effects resulting from implementing the configuration described in the present disclosure may also be derived by those skilled in the art from the embodiments of the present disclosure.

### BRIEF DESCRIPTION OF THE DRAWINGS

The drawings attached below are provided to help understand the present disclosure, and may provide embodiments of the present disclosure together with detailed description. However, the technical features of the present disclosure are not limited to specific drawings, and the features disclosed in each drawing may be combined with each other to constitute a new embodiment. Reference numerals in each drawing may indicate structural elements.

FIG. 1 illustrates an example of a communication system applied to the present disclosure.

FIG. 2 illustrates an example of a user equipment (UE) applicable to the present disclosure.

FIG. 3 illustrates an example of functional separation between next generation radio access network (NG-RAN) and 5th generation core (5GC) applicable to the present disclosure.

FIG. 4 illustrates an example of general architecture of a 5th generation (5G) system applicable to the present disclosure.

FIGS. 5a and 5b illustrate an example of a handover procedure from 5GS to EPS according to an embodiment of the present disclosure.

FIGS. 6a and 6b illustrate an example of mobility-related procedures from 5GS to EPS according to an embodiment of the present disclosure.

FIG. 7 illustrates an example of a procedure for transmitting CSG-related information without RAN impact according to an embodiment of the present disclosure.

FIG. 8 illustrates an example of a procedure for transmitting CSG-related information based on RAN support according to an embodiment of the present disclosure.

FIGS. 9a and 9b illustrate an example of mobility-related procedures from EPS to 5GS according to an embodiment of the present disclosure.

FIG. 10 illustrates an example of a procedure for transmitting allowed CAG information according to an embodiment of the present disclosure.

FIG. 11 illustrates an example of a procedure for transmitting CSG-related information according to an embodiment of the present disclosure.

FIG. 12 illustrates an example of a procedure for receiving CSG-related information according to an embodiment of the present disclosure.

FIG. 13 illustrates an example of transmitting CSG-related information according to an embodiment of the present disclosure.

### DETAILED DESCRIPTION

The following embodiments are combinations of components and features of the present disclosure in predetermined forms. Each component or feature may be considered optional unless explicitly stated otherwise. Each component or feature may be implemented without being combined with other components or features. Also, an embodiment of the present disclosure may be configured by combining some components and/or features. The order of operations described in the embodiments of the present disclosure may be changed. Some configurations or features of one embodiment may be included in another embodiment, or may be replaced with corresponding configurations or features of another embodiment.

In the description of the drawings, procedures or steps that may obscure the gist of the present disclosure are not described, and procedures or steps that can be understood at the level of those skilled in the art are also not described.

Throughout the specification, when a part is said to “comprise” or “include” a component, this means that it may further include other components rather than excluding other components unless specifically stated to the contrary. Also, terms such as “unit”, “device”, and “module” described in the specification mean a unit that processes at least one function or operation, which may be implemented by hardware, software, or a combination of hardware and software. Also, “a” or “an”, “one”, “the” and similar related words may be used in a sense including both singular and plural in the context of describing the present disclosure (particularly in the context of the claims below) unless otherwise indicated herein or clearly contradicted by context.

In this specification, the embodiments of the present disclosure have been described focusing on the data transmission and reception relationship between a base station and a mobile station. Here, the base station has meaning as a terminal node of a network that directly communicates with a mobile station. Specific operations described as being performed by a base station in this document may in some cases be performed by an upper node of the base station.

That is, various operations performed for communication with a mobile station in a network consisting of multiple network nodes including a base station may be performed by the base station or other network nodes other than the base station. At this time, ‘base station’ may be replaced by terms such as fixed station, Node B, eNB (eNode B), gNB (gNode B), ng-eNB, advanced base station (ABS), or access point.

Also, in the embodiments of the present disclosure, a terminal may be replaced by terms such as user equipment (UE), mobile station (MS), subscriber station (SS), mobile subscriber station (MSS), mobile terminal, or advanced mobile station (AMS).

Also, a transmitting end refers to a fixed and/or mobile node that provides data service or voice service, and a receiving end refers to a fixed and/or mobile node that receives data service or voice service. Therefore, in the case of uplink, a mobile station may be a transmitting end and a base station may be a receiving end. Similarly, in the case of downlink, a mobile station may be a receiving end and a base station may be a transmitting end.

The embodiments of the present disclosure may be supported by standard documents disclosed in at least one of wireless access systems including IEEE 802.xx system, 3rd Generation Partnership Project (3GPP) system, 3GPP Long Term Evolution (LTE) system, 3GPP 5th generation (5G) New Radio (NR) system, and 3GPP2 system, and in particular, the embodiments of the present disclosure may be supported by 3GPP technical specification (TS) 38.211, 3GPP TS 38.212, 3GPP TS 38.213, 3GPP TS 38.321, and 3GPP TS 38.331 documents.

Also, the embodiments of the present disclosure may be applied to other wireless access systems and are not limited to the above-described systems. For example, they may be applicable to systems applied after the 3GPP 5G NR system and are not limited to a specific system.

That is, obvious steps or parts not described among the embodiments of the present disclosure may be described with reference to the above documents. Also, all terms disclosed in this document may be described by the above standard documents.

Hereinafter, preferred embodiments according to the present disclosure will be described in detail with reference to the accompanying drawings. The detailed description to be disclosed below together with the accompanying drawings is intended to describe exemplary embodiments of the present disclosure and is not intended to represent the only embodiment in which the technical configuration of the present disclosure may be implemented.

Also, specific terms used in the embodiments of the present disclosure are provided to help understanding of the present disclosure, and the use of such specific terms may be changed to other forms without departing from the technical spirit of the present disclosure.

The following technology may be applied to various wireless access systems such as code division multiple access (CDMA), frequency division multiple access (FDMA), time division multiple access (TDMA), orthogonal frequency division multiple access (OFDMA), single carrier frequency division multiple access (SC-FDMA), and the like.

For clarity of description below, the description is based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” means a standard document detail number. LTE/NR/6G may be collectively referred to as a 3GPP system.

Regarding background technology, terms, abbreviations, etc., used in the present disclosure, reference may be made to matters described in standard documents published before the present disclosure. For example, 36.xxx and 38.xxx standard documents may be referred to.

For terms, abbreviations, and other background technologies that may be used in this document, reference may be made to the following standard document descriptions published before this document. In particular, for LTE/Evolved Packet System (EPS) related terms, abbreviations, and other background technologies, reference may be made to 36.xxx series, 23.xxx series, and 24.xxx series, and for new radio (NR)/5G system (5GS) related terms, abbreviations, and other background technologies, reference may be made to 38.xxx series, 23.xxx series, and 24.xxx series.

Hereinafter, this specification is described based on the terms defined as above.

The three main requirement areas of 5G include (1) Enhanced Mobile Broadband (eMBB) area, (2) massive Machine Type Communication (mMTC) area, and (3) Ultra-reliable and Low Latency Communications (URLLC) area.

Some use cases may require multiple areas for optimization, and other use cases may focus only on one Key Performance Indicator (KPI). 5G supports these various use cases in a flexible and reliable way.

### Communication System Applicable to the Present Disclosure

Although not limited thereto, various descriptions, functions, procedures, proposals, methods and/or operational flowcharts of the present disclosure disclosed in this document may be applied to various fields requiring wireless communication/connection (e.g., 5G) between devices.

Hereinafter, more specific examples are illustrated with reference to drawings. In the following drawings/descriptions, the same reference numerals may illustrate the same or corresponding hardware blocks, software blocks, or functional blocks unless described otherwise.

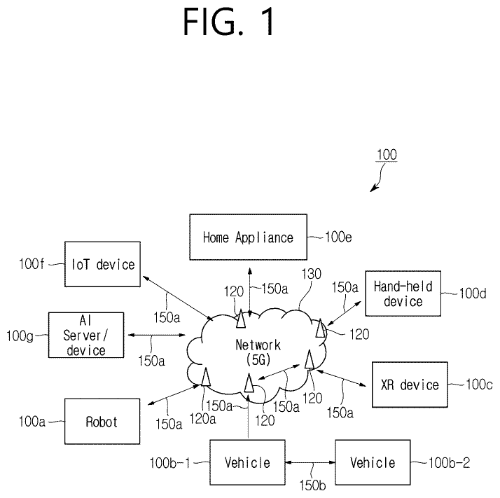

FIG. 1 illustrates an example of a communication system applied to the present disclosure.

Referring to FIG. 1, a communication system 100 applied to the present disclosure includes wireless devices, a base station, and a network. Here, a wireless device means a device that performs communication using wireless access technology (e.g., 5G NR, LTE), and may be referred to as a communication/wireless/5G device. Although not limited thereto, the wireless device may include a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 100g. For example, the vehicle may include a vehicle equipped with wireless communication function, an autonomous vehicle, a vehicle capable of performing vehicle-to-vehicle communication, etc. Here, the vehicles 100b-1 and 100b-2 may include an unmanned aerial vehicle (UAV) (e.g., drone). The XR device 100c includes augmented reality (AR)/virtual reality (VR)/mixed reality (MR) devices, and may be implemented in the form of a head-mounted device (HMD), a head-up display (HUD) installed in a vehicle, television, smartphone, computer, wearable device, home appliance, digital signage, vehicle, robot, etc. The hand-held device 100d may include a smartphone, smart pad, wearable device (e.g., smartwatch, smart glasses), computer (e.g., laptop, etc.), etc. The home appliance 100e may include TV, refrigerator, washing machine, etc. The IoT device 100f may include a sensor, smart meter, etc. For example, the base station 120 and network 130 may also be implemented as wireless devices, and a specific wireless device 120a may operate as a base station/network node for other wireless devices.

The wireless devices 100a to 100f may be connected to the network 130 through the base station 120. AI technology may be applied to the wireless devices 100a to 100f, and the wireless devices 100a to 100f may be connected to an AI server 100g through the network 130. The network 130 may be configured using a 3G network, 4G (e.g., LTE) network, or 5G (e.g., NR) network, etc. The wireless devices 100a to 100f may communicate with each other through the base station 120/network 130, but may also communicate directly (e.g., sidelink communication) without going through the base station 120/network 130. For example, the vehicles 100b-1 and 100b-2 may perform direct communication (e.g., vehicle to vehicle (V2V)/vehicle to everything (V2X) communication). Also, the IoT device 100f (e.g., sensor) may communicate directly with other IoT devices (e.g., sensor) or other wireless devices 100a to 100f.

Wireless communication/connection 150a, 150b, and 150c may be established between the wireless devices 100a to 100f/base station 120 and between base stations 120/120. Here, wireless communication/connection may be achieved through various wireless access technologies (e.g., 5G NR) such as uplink/downlink communication 150a, sidelink communication 150b (or D2D communication), and inter-base station communication 150c (e.g., relay, integrated access backhaul (IAB)). Through wireless communication/connection 150a, 150b, and 150c, wireless devices and base stations/wireless devices, and base stations and base stations may transmit/receive wireless signals to/from each other. For example, wireless communication/connection 150a, 150b, and 150c may transmit/receive signals through various physical channels. To this end, based on various proposals of the present disclosure, at least some of various configuration information setting processes for wireless signal transmission/reception, various signal processing processes (e.g., channel encoding/decoding, modulation/demodulation, resource mapping/demapping, etc.), resource allocation processes, etc., may be performed.

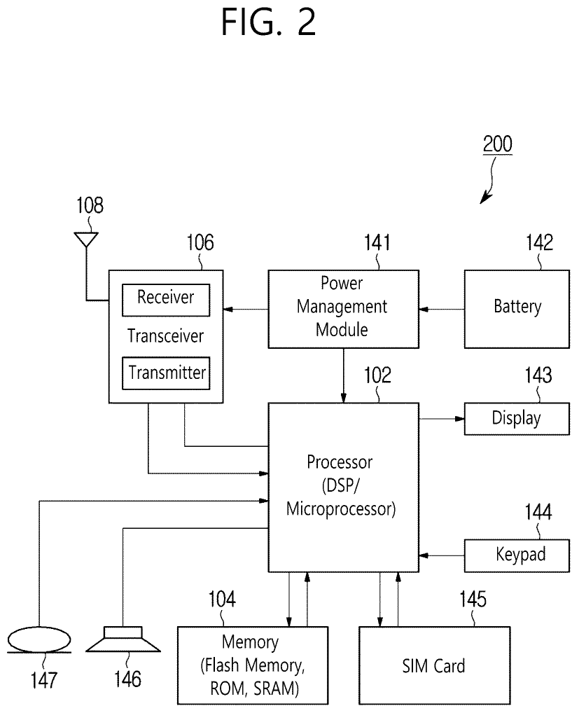

FIG. 2 illustrates an example of a UE applicable to the present disclosure.

Referring to FIG. 2, the UE 200 may include a processor 102, memory 104, transceiver 106, one or more antennas 108, power management module 141, battery 142, display 143, keypad 144, Subscriber Identification Module (SIM) card 145, speaker 146, and microphone 147.

The processor 102 may be configured to implement the descriptions, functions, procedures, proposals, methods and/or operational flowcharts disclosed herein. The processor 102 may be configured to control one or more other components of the UE 200 to implement the descriptions, functions, procedures, proposals, methods and/or operational flowcharts disclosed herein. Layers of wireless interface protocol may be implemented in the processor 102. The processor 102 may include ASIC, other chipset, logic circuit and/or data processing device. The processor 102 may be an application processor. The processor 102 may include at least one of DSP, Central Processing Unit (CPU), Graphics Processing Unit (GPU), and modem (modulator and demodulator).

The memory 104 is operably coupled with the processor 102 and may store various information for operating the processor 102. The memory 104 may include ROM, RAM, flash memory, memory card, storage medium and/or other storage device. When implementation is implemented in software, the techniques described herein may be implemented using modules (e.g., procedures, functions, etc.) that perform the descriptions, functions, procedures, proposals, methods and/or operational flowcharts disclosed herein. The modules may be stored in memory 14 and executed by the processor 102. The memory 104 may be implemented within the processor 102 or external to the processor 102, in which case it may be communicatively coupled with the processor 102 through various methods known in the art.

The transceiver 106 is operably coupled with the processor 102 and may transmit and/or receive wireless signals. The transceiver 106 may include a transmitter and a receiver. The transceiver 106 may include baseband circuitry for processing radio frequency signals. The transceiver 106 may control one or more antennas 108 to transmit and/or receive wireless signals.

The power management module 141 may manage power for the processor 102 and/or transceiver 106. The battery 142 may supply power to the power management module 141.

The display 143 may output results processed by the processor 102. The keypad 144 may receive input for use by the processor 102. The keypad 144 may be displayed on the display 143.

The SIM card 145 is an integrated circuit for securely storing International Mobile Subscriber Identity (IMSI) and related keys, and may be used to identify and authenticate subscribers in mobile phone devices such as mobile phones or computers. Also, contact information may be stored in many SIM cards.

The speaker 146 may output sound-related results processed by the processor 102. The microphone 147 may receive sound-related input for use by the processor 102.

In implementation of this specification, the UE may operate as a transmitting device in uplink and as a receiving device in downlink. In implementation of this specification, the base station may operate as a receiving device in UL and as a transmitting device in DL. In this specification, the base station may be called Node B, eNode B (eNB), gNB, and may not be limited to a specific form.

Also, for example, the UE may be implemented in various forms according to use cases/services. The UE may be configured by various components, devices/parts and/or modules. For example, each UE may include a communication device, control device, memory device, and additional components. The communication device may include communication circuitry and a transceiver. For example, the communication circuitry may include one or more processors and/or one or more memories. For example, the transceiver may include one or more transceivers and/or one or more antennas. The control device is electrically connected to the communication device, memory device, and additional components, and may control the overall operation of each UE. For example, the control device may control the electrical/mechanical operation of each UE based on programs/codes/instructions/information stored in the memory device. The control device may transmit information stored in the memory device to the outside (e.g., other communication devices) through the communication device via wireless/wired interface, or store information received from the outside (e.g., other communication devices) through the communication device via wireless/wired interface in the memory device.

The additional components may be configured variously according to the type of UE. For example, the additional components may include at least one of power device/battery, input/output (I/O) device (e.g., audio I/O port, video I/O port), driving device, and computing device. Also, the UE may be implemented in the form of, but not limited to, robot (100a in FIG. 1), vehicle (100b-1 and 100b-2 in FIG. 1), XR device (100c in FIG. 1), portable device (100d in FIG. 1), home appliance (100e in FIG. 1), IoT device (100f in FIG. 1), digital broadcasting terminal, hologram device, public safety device, MTC device, medical device, fintech device (or financial device), security device, climate/environment device, AI server/device (100g in FIG. 1), base station (120 in FIG. 1), network node. The UE may be used in mobile or fixed locations according to use cases/services.

All of the various components, devices/parts and/or modules of the UE may be connected to each other through wired interface, or at least some may be wirelessly connected through the communication device. Also, each component, device/part and/or module of the UE may further include one or more elements. For example, the control device may be configured by one or more processor sets. For example, the control device may be configured by a set of communication control processor, Application Processor (AP), Electronic Control Unit (ECU), graphics processing unit, and memory control processor. As another example, the memory device may be configured by RAM, Dynamic RAM (DRAM), ROM, flash memory, volatile memory, non-volatile memory and/or combinations thereof.

### 5G System Architecture Applicable to the Present Disclosure

The 5G system is an advanced technology from 4th generation LTE mobile communication technology that supports new Radio Access Technology (RAT), extended LTE (eLTE) as an extended technology of Long Term Evolution (LTE), non-3GPP (e.g., WLAN) access, etc., through evolution or clean-state structure of existing mobile communication network structure.

The 5G system is defined service-based, and interactions between Network Functions (NFs) within the architecture for the 5G system can be represented in two ways as follows:
Reference point representation: Represents interactions between NF services within NFs described by point-to-point reference points (e.g., N11) between two NFs (e.g., AMF and SMF).
Service-based representation: Network functions (e.g., AMF) within the Control Plane (CP) allow other authorized network functions to access their services. This representation also includes point-to-point reference points when necessary.

5G Core (5GC) may include various components, among which access and mobility management function (AMF), session management function (SMF), policy control function (PCF), user plane function (UPF), application function (AF), unified data management (UDM), and non-3GPP interworking function (N3IWF) are included.

The UE is connected to a data network through UPF via next generation radio access network (NG-RAN) including gNB. The UE may receive data service through untrusted non-3GPP access, such as wireless local area network (WLAN). To connect non-3GPP access to the core network, N3IWF may be deployed.

N3IWF performs the function of managing interworking between non-3GPP access and the 5G system. When the UE is connected to non-3GPP access (e.g., WiFi referred to as IEEE 802.11), the UE may be connected to the 5G system through N3IWF. N3IWF performs control signaling with AMF and is connected to UPF through N3 interface for data transmission.

AMF may manage access and mobility in the 5G system. AMF may perform the function of managing non-access stratum (NAS) security. AMF may perform the function of handling mobility in idle state.

UPF performs the function of a gateway for transmitting and receiving user data. The UPF node may perform all or part of the user plane functions of serving gateway (S-GW) and packet data network gateway (P-GW) of 4th generation mobile communication.

UPF operates as a boundary point between next generation RAN (NG-RAN) and core network, and is an element that maintains data path between gNB and SMF. Also, when the UE moves across an area served by gNB, UPF performs the role of mobility anchor point. UPF may perform the function of handling PDU. For mobility within NG-RAN (e.g., NG-RAN defined after 3GPP Release-15), UPF may route packets. Also, UPF may function as an anchor point for mobility with other 3GPP networks (e.g., RAN defined before 3GPP Release-15), for example, UMTS (universal mobile telecommunications system) terrestrial radio access network (UTRAN), evolved-UTRAN (E-UTRAN), or GSM (global system for mobile communication)/EDGE (enhanced data rates for global evolution) radio access network (GERAN). UPF may correspond to a termination point of data interface toward data network.

PCF is a node that controls operator policy. AF is a server for providing various services to the UE. UDM is a server that manages subscriber information, like home subscriber server (HSS) of 4th generation mobile communication. UDM 460 stores and manages subscriber information in unified data repository (UDR).

SMF may perform the function of allocating Internet protocol (IP) address of the UE. And SMF may control protocol data unit (PDU) session.

For convenience of description below, reference numerals for AMF, SMF, PCF, UPF, AF, UDM, N3IWF, gNB, or UE may be omitted, and may operate with reference to matters described in standard documents published before this document.

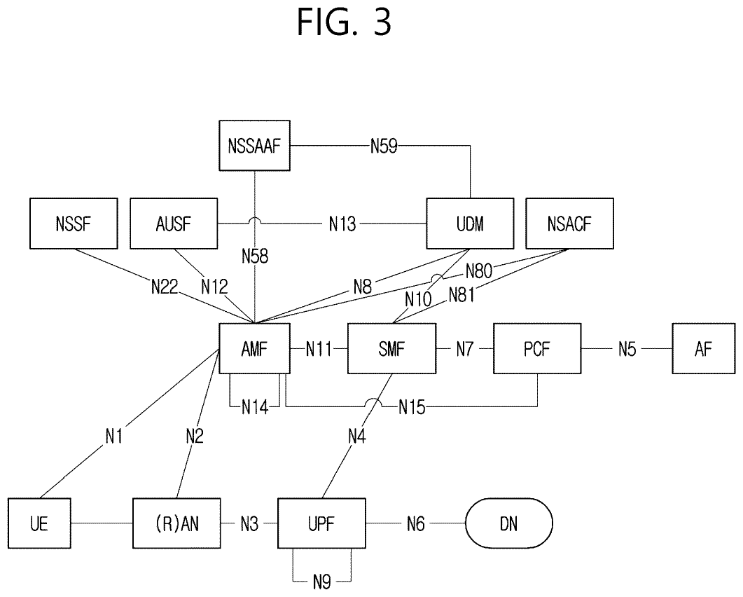

FIG. 3 illustrates an example of functional separation between NG-RAN and 5th generation core (5GC) applicable to the present disclosure.

Referring to FIG. 3, the UE is connected to a data network (DN) through next generation RAN. The control plane function (CPF) node performs all or part of the functions of mobility management entity (MME) of 4th generation mobile communication, and all or part of the control plane functions of serving gateway (S-GW) and PDN gateway (P-GW). The CPF node includes AMF and SMF.

The UPF node performs the function of a gateway through which user data is transmitted and received.

Authentication server function (AUSF) authenticates and manages the UE. Network Slice Selection Function (NSSF) is a node for network slicing as described below.

Network exposure function (NEF) provides a mechanism to securely expose services and functions of 5G core.

The reference points shown in FIG. 3 are as follows. N1 represents a reference point between UE and AMF. N2 represents a reference point between (R)AN and AMF. N3 represents a reference point between (R)AN and UPF. N4 represents a reference point between SMF and UPF. N5 represents a reference point between PCF and AF. N6 represents a reference point between UPF and DN. N7 represents a reference point between SMF and PCF. N8 represents a reference point between UDM and AMF. N9 represents a reference point between UPFs. N10 represents a reference point between UDM and SMF. N11 represents a reference point between AMF and SMF. N12 represents a reference point between AMF and AUSF. N13 represents a reference point between UDM and AUSF. N14 represents a reference point between AMFs. N15 represents a reference point between PCF and AMF in non-roaming scenario, and a reference point between AMF and PCF of visited network in roaming scenario. N16 represents a reference point between SMFs. N22 represents a reference point between AMF and NSSF. N30 represents a reference point between PCF and NEF. N33 may represent a reference point between AF and NEF, and the above-mentioned entities and interfaces may be configured with reference to matters described in standard documents published before this document. N58 represents a reference point between AMF and NSSAAF. N59 represents a reference point between UDM and NSSAAF. N80 represents a reference point between AMF and NSACF. N81 represents a reference point between SMF and NSACF.

The wireless interface protocol is based on 3GPP radio access network specifications. The wireless interface protocol consists horizontally of physical layer, data link layer, and network layer, and is vertically divided into user plane for data information transmission and control plane for control signal (signaling) transmission.

Protocol layers can be divided into L1 (layer-1), L2 (layer-2), and L3 (layer-3) based on the lower three layers of the open system interconnection (OSI) reference model widely known in communication systems.

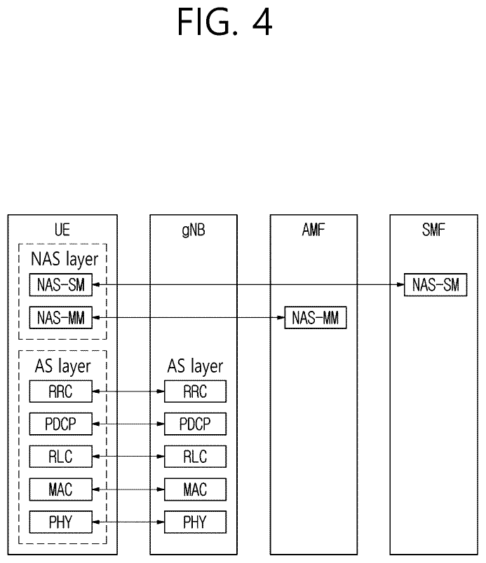

Hereinafter, the present disclosure describes each layer of wireless protocol. FIG. 4 illustrates an example of general architecture of a 5th generation (5G) system applicable to the present disclosure.

Referring to FIG. 4, the access stratum (AS) layer may include physical (PHY) layer, medium access control layer, radio link control (RLC) layer, packet data convergence protocol (PDCP) layer, and radio resource control (RRC) layer, and operations based on each layer may operate with reference to matters described in standard documents published before this document.

### Specific Embodiments of the Present Disclosure

The present disclosure relates to an apparatus and method for supporting inter-system handover in a wireless communication system. Specifically, the present disclosure relates to an apparatus and method for interworking a CAG cell of 5GS and a CSG cell of EPS in a wireless communication system.

3GPP is researching how to support femtocells in 5GS under the topic “study on system aspects of 5G NR femto” for Rel-19. Specifically, research is being conducted on the following objectives. The study document on system aspects of 5G NR femto in SP-231797 defines the following objectives:

### 4. Objective

The following aspects will be studied:

WT #1: Based on RAN3 outcome, enhance the overall architecture and enable the required functional and procedural changes for supporting 5G NR Femto deployment.

NOTE 1: It assumed that RAN3 will study the need for potential architecture enhancement for supporting 5G NR Femto deployment.

WT #2: How to enable interworking between CAG and CSG cells.

NOTE 2: It is expected that EPC (e.g., MME), E-UTRAN and NG-RAN impacts are avoided.

NOTE 3: It is assumed that the existing CAG concept defined for PNI-NPN is re-used for Femto access control without impacts to PNI-NPN.

WT #3: Study whether and how to support enabling the provisioning of subscribers allowed to access CAG cell and to manage access control by the CAG owner or an authorized administrator.

NOTE 4: Ownership of the 5G NR Femto (or CAG or both) concept and a mechanism will be defined in coordination with SA3.

As described above, 5GS uses a closed access group (CAG) for access control to femtocells. Accordingly, research is being conducted on methods to interwork closed subscriber group (CSG) used for access control to femtocells in 4GS and CAG of 5GS. The present disclosure presents a solution to support this.

According to the prior art, access control for CSG is performed by the MME. For example, when a terminal performs attach and/or tracking area update (TAU) to EPC through a CSG cell, the eNB notifies the MME of identification information (e.g., CSG ID) of the CSG cell. The MME determines whether the terminal's access to the corresponding CSG cell is allowed based on the terminal's subscriber information and the identification information of the CSG cell, and notifies the eNB of information about CSG membership status. The information about CSG membership status may include a CSG membership indication indicating whether the corresponding terminal is a CSG member. For example, the MME may notify the eNB of the terminal's CSG membership indication information. Among CSG cells, there is a hybrid cell that is accessible to both CSG members and non-CSG members. The MME can notify the eNB whether the terminal is a CSG member, thereby allowing different policies to be applied to CSG members and non-CSG members in a hybrid cell.

If the cell to which the terminal is connected is a CSG cell and not a hybrid cell, and the CSG ID of the cell to which the terminal is connected is not included in the terminal's subscriber information, the MME may reject the terminal's attach request. Also, when the target cell is a CSG cell during the handover process, the handover required message transmitted from the source eNB to the MME includes the CSG ID and cell access mode (e.g., hybrid mode) of the target cell. The source MME checks whether the terminal can receive service in the target cell based on the information included in the handover required message and the terminal's subscriber information. The source MME determines whether to continue performing the terminal's handover based on the verification result. That is, it checks whether the CSG ID of the target cell is included in the terminal's subscriber information. At this time, if the CSG ID of the target cell is not included in the terminal's subscriber information and the target cell is not a hybrid cell, the source MME may reject the handover request from the source eNB.

Meanwhile, access control for CAG is performed by gNB and AMF. For example, when a terminal performs initial registration or transitions from connection management (CM)-IDLE state to CM-CONNECTED state, the gNB transmits to the AMF a list of CAGs supported by the cell to which the terminal is connected. At this time, the AMF checks whether the CAG ID included in the terminal's subscriber information exists in the CAG list supported by the cell to which the terminal is connected, based on the CAG list included in the terminal's subscriber information and the CAG list supported by the cell to which the terminal is connected from the gNB. If the CAG ID included in the terminal's subscriber information exists in the CAG list supported by the cell to which the terminal is connected, the AMF can process the terminal's request. On the other hand, if the CAG ID included in the terminal's subscriber information does not exist in the CAG list supported by the cell to which the terminal is connected, the AMF may reject the terminal's request.

On the other hand, the AMF notifies the gNB of a mobility restriction list including an allowed CAG list to prevent the terminal from being moved to an unauthorized CAG cell during handover. When performing handover, the gNB may compare at least one CAG ID supported by the target cell with the terminal's allowed CAG list, and determine whether to handover to the target cell based on the comparison result. For example, if at least one supported CAG ID is included in the terminal's allowed CAG list, the gNB can determine the target cell as an allowed cell and control the terminal to be handed over to the target cell.

As described above, since the access control method for CAG and the access control method for CSG are different from each other, additional functions need to be defined to interwork CAG and CSG.

Therefore, the present disclosure proposes various embodiments for interworking CAG and CSG. The proposed embodiments may be configured to include at least one operation, configuration, and/or steps described below. Also, at least two or more of the proposed embodiments may be combined with each other, or one embodiment may be used to complement at least one other embodiment. Hereinafter, the terminal may include user equipment (UE).

### Embodiment #1: Method for Interworking Cells without RAN Impact

Generally, when inter-system handover from gNB to eNB or inter-system handover from eNB to gNB is performed, a target cell is selected without information about CAG and/or CSG, and handover to the selected target cell is performed. The present disclosure proposes a method for interworking CAG cells and CSG cells without changing the handover procedure at the base station.

### Embodiment #1-1: Example of Performing Handover from 5GC to EPC

When handover from 5GC to EPC occurs, the AMF checks whether the target cell is a CSG cell. The AMF may check whether the target cell is a CSG cell based on the target cell's tracking area identity (TAI) and global eNB ID information. Alternatively, the AMF may obtain target cell ID information included in the source to target transparent container received from the gNB and check whether the target cell is a CSG cell based on the target cell ID.

For this purpose, information related to CSG may be configured in the AMF. For example, the information related to CSG may include at least one of eNB ID supporting CSG cells, candidate cell ID supporting CSG cells, or mapping information of CSG and CAG. The mapping information of CSG and CAG may include at least one of CSG ID and CAG ID mapped to each CSG ID, or cell access mode.

According to one embodiment, the AMF may obtain the target cell ID included in the source to target transparent container only when the target cell is an eNB and allowed CSG ID information is included in the terminal's subscriber information. The terminal's subscriber information may include CSG subscription data. For example, the CSG subscription data may include a list of CSG IDs that the terminal is allowed to use, i.e., an allowed CSG list. The AMF may check whether the target cell is a CSG cell by comparing the information related to CSG configured in the AMF with the target cell ID.

According to one embodiment, in a situation where the AMF knows the CAG list supported by the serving gNB, when the terminal's handover occurs, the AMF may infer the serving CAG ID based on the terminal's allowed CAG list and the CAG list supported by the serving gNB. For example, the AMF may infer which CAG ID is currently being used by comparing the terminal's allowed CAG list with the CAG list supported by the serving gNB. The AMF may directly receive the CAG list supported by the serving gNB from the serving gNB, or infer information about the CAG list supported by the serving gNB based on information included in the initial UE message received from the serving gNB. When the CSG ID mapped to the inferred serving CAG ID is included in the information related to CSG configured in the AMF, the AMF may determine to perform handover to the corresponding CSG cell based on the corresponding CSG ID information. When the target cell is confirmed to be a CSG cell, the AMF may transmit a forward relocation request message including at least one of the target cell's CSG ID information or CSG membership indication to the MME. The MME receiving the forward relocation request message may transmit a message (e.g., handover request message) including CSG ID information and CSG membership indication to the target eNB. Through this, the terminal can handover to the CSG cell.

### Embodiment #1-2: Example of Performing Handover from EPC to 5GC

When handover from EPC to 5GC occurs, it can operate as follows.

When the source eNB transmits a handover required message to the MME, the MME may transmit a forward relocation request message to the AMF based on the target cell's ID information.

When the target cell is a CAG cell, the gNB may transmit a handover request acknowledge message including the CAG list supported by the target cell to the AMF. The AMF may compare the CAG list supported by the target cell with the terminal's subscriber information to determine whether to release the terminal's connection after handover. Alternatively, the gNB may directly reject the terminal's handover. That is, the gNB may receive a handover request message including an allowed CAG list from the AMF and directly reject the terminal's handover based on the allowed CAG list.

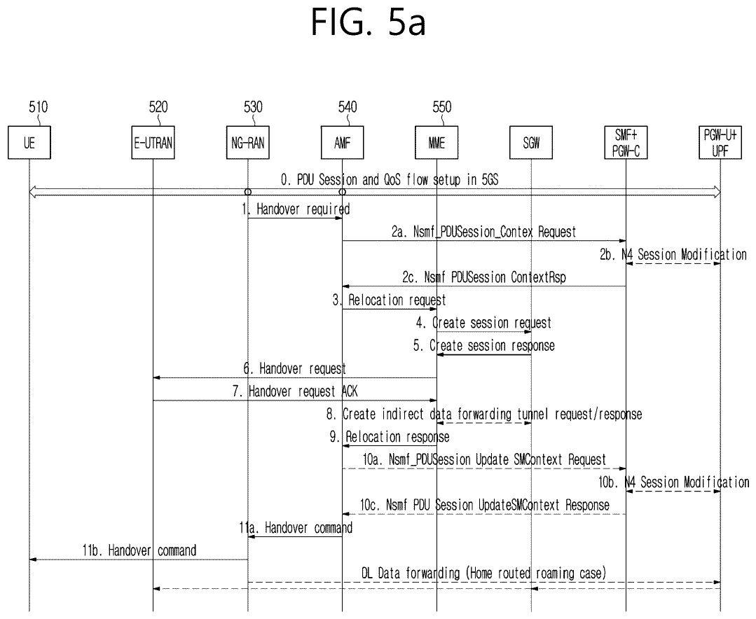

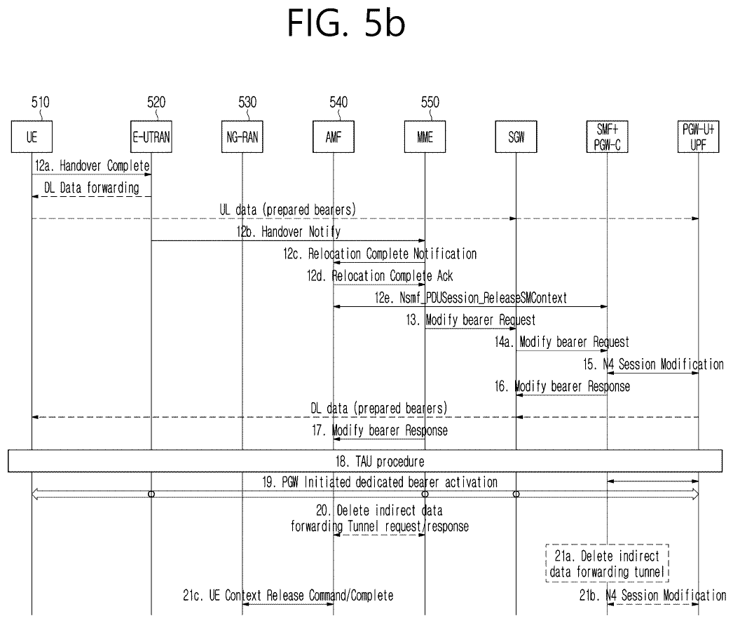

FIGS. 5a and 5b illustrate an example of a handover procedure from 5GS to EPS according to an embodiment of the present disclosure. Unless otherwise described below, the procedures of FIGS. 5a and 5b may basically follow the handover procedure from 5GS to EPS using the N26 interface of clause 4.11.1.2.1 of TS 23.502. For example, the remaining steps except step 3 in the procedures of FIGS. 5a and 5b may follow the handover procedure from 5GS to EPS using the N26 interface of clause 4.11.1.2.1 of TS 23.502.

Referring to FIGS. 5a and 5b, in step 0, UE 510 establishes a PDU session and QoS flow in 5GS. UE 510 may receive service through a femtocell. The femtocell supports CAG ID, and the subscriber information of UE 510 may include allowed CAG ID supported by the femtocell.

In step 1, NG-RAN 530 determines that UE 510 should be handed over to E-UTRAN 520 and transmits a handover required message to AMF 540. The handover required message may include the target eNB ID.

In steps 2a to 2c, AMF 540 confirms that the handover type is handover to E-UTRAN 520 based on the target eNB ID and selects MME 550. Steps 2a to 2c may be performed identically to steps 2a to 2c of TS 23.502 clause 4.11.1.2.1.

In step 3, AMF 540 transmits a forward relocation request message to MME 550. At this time, AMF 540 can recognize that the base station hands over the UE to a CSG cell based on at least one of CSG-related information configured in AMF 540, UE's subscriber information, target cell ID information, CAG ID information for the current serving cell, or target eNB ID and TAI information. Here, the CSG-related information configured in the AMF may include at least one of cell ID of candidate eNB cells capable of handover, eNB ID, TAI, or mapping information of CSG and CAG. The mapping information of CSG and CAG may include at least one of CSG ID and CAG ID mapped to each CSG ID, or cell access mode. When there is no mapping information of CSG and CAG, the CSG ID value itself may become the CAG ID value. The UE's subscriber information may include at least one of an allowed CSG list or an allowed CAG list available to the UE. The target cell ID information may be target cell ID information included in the source to target transparent container in the handover required message. Also, the target eNB ID and TAI information may be information included in the handover required message.

AMF 540 recognizes that the target cell is a CSG cell based on at least one piece of information as described above, and transmits a forward relocation request message including CSG ID information and CSG membership indication of the target cell to MME 550. According to one embodiment, the CSG membership indication may be included only when the target cell is a hybrid cell. If the CSG ID of the target cell is not included in the allowed CSG list in the UE's subscriber information, AMF 540 may transmit a handover preparation failure message to the gNB of NG-RAN 530.

Steps 4 to 21 may be performed identically to steps 4 to 21 of TS 23.502 clause 4.11.1.2.1. For example, in step 6, MME 540 transmits a handover request message to the target eNB of E-UTRAN 520. At this time, the handover request message may include at least one of CSG ID information or CSG membership indication of the target cell. Through this, the UE can handover to the CSG cell.

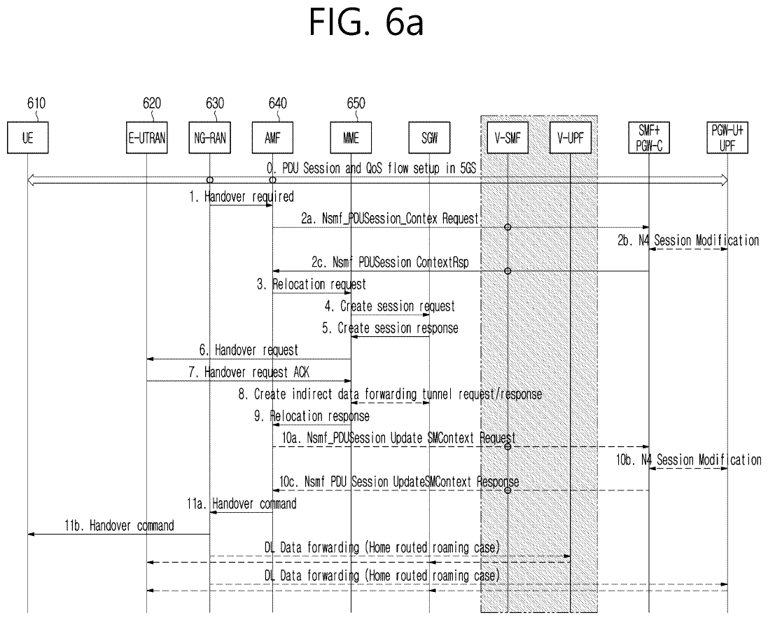

FIGS. 6a and 6b illustrate an example of mobility-related procedures from 5GS to EPS according to an embodiment of the present disclosure. The procedures of FIGS. 6a and 6b may basically follow the handover procedure from 5GS to EPS using the N26 interface of clause 4.11.1.2.1 of TS 23.502. For example, the remaining steps except step 3 below in the procedures of FIGS. 6a and 6b may follow the handover procedure from 5GS to EPS using the N26 interface of clause 4.11.1.2.1 of TS 23.502.

Before the procedure shown in FIGS. 6a and 6b is triggered, CSG-related information of candidate target eNB cells may be configured in AMF 640. For example, the CSG-related information may include at least one of eNB ID supporting CSG cells, candidate cell ID supporting CSG cells, or mapping information of CSG and CAG. The mapping information of CSG and CAG may include at least one of CSG ID and CAG ID mapped to each CSG ID, or cell access mode.

According to clause 5.5.1.2.2 of TS 23.401, the target eNB of E-UTRAN 620 should verify the CSG ID provided by target MME 650. Therefore, in step 3, when recognizing that UE 610 is moved to EPS, AMF 640 may include necessary information (e.g., CSG ID) for CSG ID verification of the target eNB in the forward relocation request message. AMF 640 may determine the CSG ID of the target cell and necessary information to be included in the forward relocation request message based on CSG-related information configured in AMF 640. For example, AMF 640 may determine whether the handover target cell of UE 610 is a CSG cell based on information configured in the AMF and UE subscriber information. When the handover target cell of UE 610 is a CSG cell, AMF 640 may transmit a forward relocation request message including the CSG ID and CSG membership indication of the target cell to MME 650.

AMF 640 checks whether the target cell is a CSG cell allowed for the terminal based on the subscriber information of UE 610 and the CSG ID of the target cell, and may stop the handover of UE 610 if it is not an allowed CSG cell. At this time, AMF 640 may transmit a handover preparation failure message to the gNB of NG-RAN 630.

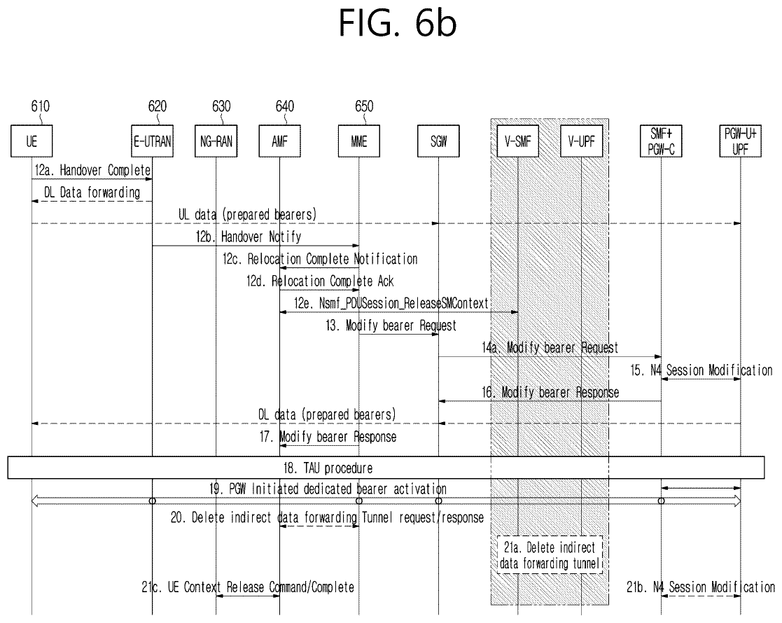

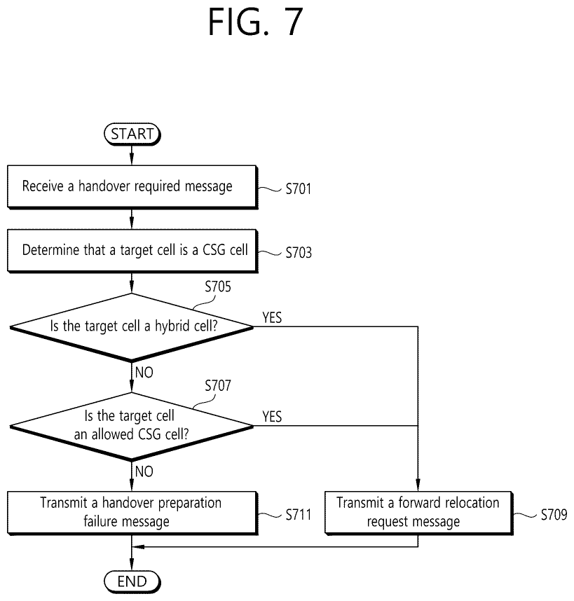

FIG. 7 illustrates an example of a procedure for transmitting CSG-related information without RAN impact according to an embodiment of the present disclosure. FIG. 7 exemplifies a method performed by an AMF. FIG. 7 may be performed when handover from 5GS to EPS occurs.

Referring to FIG. 7, in step S701, the AMF receives a handover required message. The AMF may receive a handover required message including at least one of target eNB ID or target cell ID from NG-RAN from the source gNB.

In step S703, the AMF determines that the target cell is a CSG cell. The AMF may determine that the target cell is a CSG cell based on CSG-related information pre-configured in the AMF. The CSG-related information may include at least one of cell ID of candidate eNB cells capable of handover, eNB ID, TAI, or mapping information of CSG and CAG. The mapping information of CSG and CAG may include at least one of CSG ID and CAG ID mapped to each CSG ID, or cell access mode. For example, the AMF may determine whether the target cell is a CSG cell based on whether the target eNB ID or target cell ID included in the handover required message is included in the CSG-related information. The present disclosure assumes a case where the target cell is CSG.

In step S705, the AMF determines whether the target cell is a hybrid cell. The AMF may check whether the target cell is a hybrid cell based on the cell access mode in the CSG-related information configured in the AMF. That is, the AMF may check whether the target cell is a hybrid cell that supports both CSG members and non-CSG members based on the cell access mode in the configured CSG-related information.

If the target cell is a hybrid cell, in step S709, the AMF transmits a forward relocation request message. That is, if the target cell is a hybrid cell accessible to both CSG members and non-CSG members, the AMF transmits a forward relocation request message to the MME. At this time, the forward relocation request message may include the CSG ID of the target cell and CSG membership indication. The CSG membership indication may indicate whether the corresponding terminal is a CSG member. The reason why the CSG membership indication is included in the forward relocation request message is because the policy applied to each terminal at the target base station may differ based on whether it is a CSG member.

If the target cell is not a hybrid cell, in step S707, the AMF determines whether the target cell is an allowed CSG cell. The AMF may determine whether the target cell corresponds to a CSG cell for which the terminal's use is allowed based on the target cell ID and the terminal's subscriber information. The terminal's subscriber information may include at least one of an allowed CSG list or an allowed CAG list available to the terminal. That is, the AMF may compare whether at least one CSG ID in the allowed CSG list is the same as the target cell ID. If at least one CSG ID in the allowed CSG list is the same as the target cell ID, the AMF may determine the target cell as an allowed CSG cell. On the other hand, if at least one CSG ID in the allowed CSG list is not the same as the target cell ID, the AMF may determine that the target cell is not an allowed CSG cell.

If the target cell is an allowed CSG cell, in step S709, the AMF transmits a forward relocation request message. The AMF transmits a forward relocation request message including the CSG ID of the target cell to the MME. According to one embodiment, the forward relocation request message may further include a CSG membership indication.

If the target cell is not an allowed CSG cell, in step S711, the AMF transmits a handover preparation failure message. That is, if the target cell is not an allowed CSG cell, the AMF determines that the terminal cannot access the target cell and may stop the terminal's handover by transmitting a handover preparation failure message to NG-RAN. The handover preparation failure message may include a handover preparation failure reason or handover abort reason.

In the embodiment described with reference to FIG. 7, the forward relocation request message may include at least one of the CSG ID of the target cell or CSG membership indication. According to one embodiment, the CSG membership indication may be included in the forward relocation request message only when the target cell is a hybrid cell.

As described with reference to FIG. 7, the MME may receive a forward relocation request message including at least one of the CSG ID of the target cell or CSG membership indication from the AMF. The MME may transmit a handover request message including at least one of the CSG ID of the target cell or CSG membership indication to the eNB. Accordingly, the terminal can handover from 5GS to a CSG cell of EPS.

### Embodiment #2: Interworking Method with RAN Support

When handover from 5GS to EPS occurs and the target cell is a CSG cell, the source gNB may transmit a handover required message including information about the CSG cell. For this, the gNB should know the CSG information of the target cell. The gNB and/or eNB can recognize nearby eNBs and/or gNBs based on automatic neighbor cell relation (ANR). ANR is as defined in clause 15.3.3 of TS 38.300 and/or clause 22.3.2a of TS 36.300. For example, the gNB and/or eNB can find at least one neighbor cell based on operator configuration, OAM, and UE measurement reports, and recognize the existence of neighbor eNBs and/or gNBs based on this. Also, after the gNB and/or eNB recognizes nearby eNBs and/or gNBs based on ANR, they can exchange information about each other with nearby eNBs and/or gNBs using configuration transfer procedures. For example, the gNB and/or eNB can transmit CAG and/or CSG information (e.g., CAG list, CSG list, cell access mode) of cells they support to nearby eNBs and/or gNBs using configuration transfer signaling, and receive cell CAG and/or CSG information supported by the corresponding base station from nearby eNBs and/or gNBs. The configuration transfer procedure is as defined in clause 5.26 of TS 23.501 and/or clause 5.14 of TS 23.401.

If CAG ID and CSG ID are mapped 1:1 and CAG ID and CSG ID have the same value, the gNB and/or eNB may use only one of either the CAG list or CSG list, and convert and use it as the other list as needed.

The source gNB may determine whether the target cell is a CSG cell using information obtained based on ANR and/or configuration transfer procedures as described above. If the target cell is a CSG cell, the source gNB may transmit a handover required message including CSG information about the target cell to the AMF. The CSG information about the target cell may include at least one of CSG ID or cell access mode.

The AMF transmits a forward relocation request message to the MME based on the CSG information about the target cell. The forward relocation request message may include at least one of the CSG ID or CSG membership indication of the target cell. The CSG membership indication may be based on CSG subscription data included in subscriber information. The CSG subscription data may include a list of CSG IDs for which the terminal's use is allowed. For example, the AMF may generate a CSG membership indication indicating whether the terminal is a CSG member based on CSG subscription data included in the terminal's subscriber information, and may transmit a forward relocation request message including the generated CSG membership indication to the MME.

Before transmitting the forward relocation request message to the MME, the AMF may check whether the CSG ID of the target cell is included in the list of allowed CSG IDs in the CSG subscription data, and may determine whether to continue performing handover based on the verification result. If the CSG ID of the target cell is not included in the list of allowed CSG IDs in the CSG subscription data, the AMF may decide to abort the handover. When handover abort is decided, the AMF may transmit a handover preparation failure message to the source gNB. The handover preparation failure message may include the reason for handover abort. The handover abort reason may indicate that the CSG ID of the target cell does not correspond to a CSG ID allowed for the terminal.

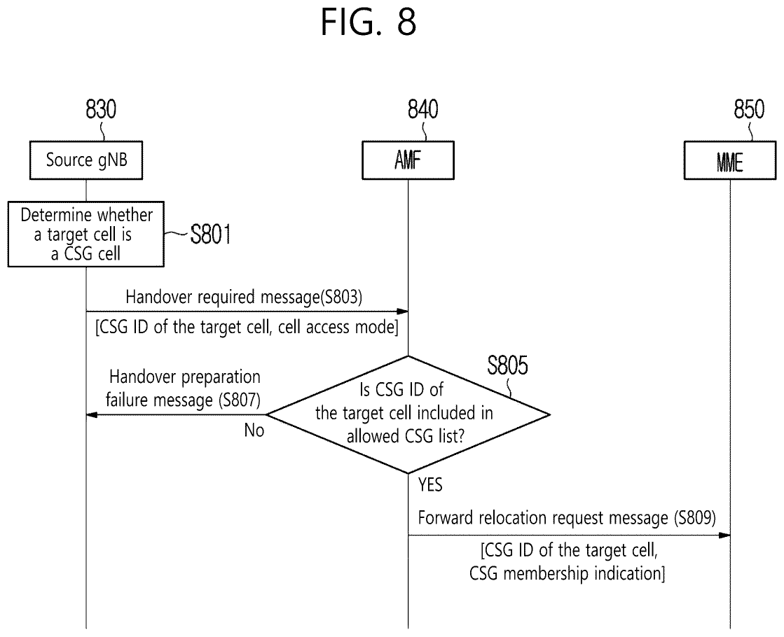

FIG. 8 illustrates an example of a procedure for transmitting CSG-related information based on RAN support according to an embodiment of the present disclosure. FIG. 8 is an example of a procedure for interworking CSG cells and CAG cells through RAN support when handover from 5GS to EPS occurs.

Referring to FIG. 8, in step S801, the source gNB 830 determines whether the target cell is a CSG cell. The source gNB 830 may determine whether the terminal's handover target cell is a CSG cell based on information previously exchanged with neighboring eNBs and/or gNBs based on ANR. For example, the source gNB 830 may obtain in advance CSG information and/or CAG information supported by each neighboring eNB and/or gNB based on configuration transfer signaling. The CSG information may include at least one of a CSG list including CSG IDs supported by the corresponding eNB or cell access mode of CSG cells corresponding to each CSG ID. The CAG information may include a CAG list including CAG IDs supported by the corresponding gNB. The source gNB 830 may check whether the target cell is a CSG cell by comparing the ID of the terminal's handover target cell with the CSG list and/or CAG list supported by each neighboring eNB and/or gNB. The present disclosure assumes a case where the target cell is a CSG cell.

When the target cell is a CSG cell, in step S803, the source gNB 830 transmits a handover required message to the AMF 840. The handover required message may include at least one of the CSG ID or cell access mode of the target cell. In other words, when the target cell is a CSG cell, the source gNB may recognize that the terminal should be handed over from 5GS to EPS, and transmit a handover required message including at least one of the CSG ID or cell access mode of the target cell to the AMF 840 for interworking between CAG cells and CSG cells.

In step S805, the AMF 840 checks whether the CSG ID of the target cell is included in the allowed CSG list. The allowed CSG list is a list containing IDs of CSG cells for which the terminal's use is allowed, and may be obtained from CSG subscription data included in the terminal's subscriber information. When the AMF 840 receives a handover required message including at least one of the CSG ID or cell access mode of the target cell from the source gNB 830, it may determine whether the CSG ID of the target cell is included in the allowed CSG list included in the terminal's subscriber information.

If the CSG ID of the target cell is not included in the allowed CSG list, in step S807, the AMF 840 transmits a handover preparation failure message to the source gNB 830. That is, if the CSG ID of the target cell is not included in the allowed CSG list, the AMF 840 may determine that handover to the CSG cell that is the target cell is impossible. The AMF 840 may stop the terminal's handover by transmitting a handover preparation failure message to the source gNB 830. At this time, the handover preparation failure message may include the reason for handover abort. The handover abort reason may indicate that the CSG ID of the target cell is not included in the terminal's allowed CSG list.

If the CSG ID of the target cell is included in the allowed CSG list, in step S809, the AMF 840 transmits a forward relocation request message. The forward relocation request message may include at least one of the CSG ID or CSG membership indication of the target cell.

According to one embodiment, the MME 850 that received the forward relocation request message may transmit a handover request message including the CSG ID of the target cell or the terminal's CSG membership indication to the target eNB supporting the target cell. Through this, the terminal can handover to the CSG cell supported by the target eNB. Here, the CSG membership indication may be used by the eNB to determine the policy to be applied to the terminal. For example, when the target cell is a hybrid cell, the terminal may control different policies to be applied to CSG members and non-CSG members.

### Embodiment #3: Interaction between CAG Cells and CSG Cells Based on Mapping Configuration Information in AMF

eNB and gNB may trigger handover or redirection to CAG cells or CSG cells based on at least one of ANR information or pre-configuration information within RAN. At least one of candidate target eNB cells, CSG IDs associated with target eNB cells, CAG IDs mapped to CSG IDs, or information indicating whether the target eNB cell is a hybrid cell may be configured in the AMF.

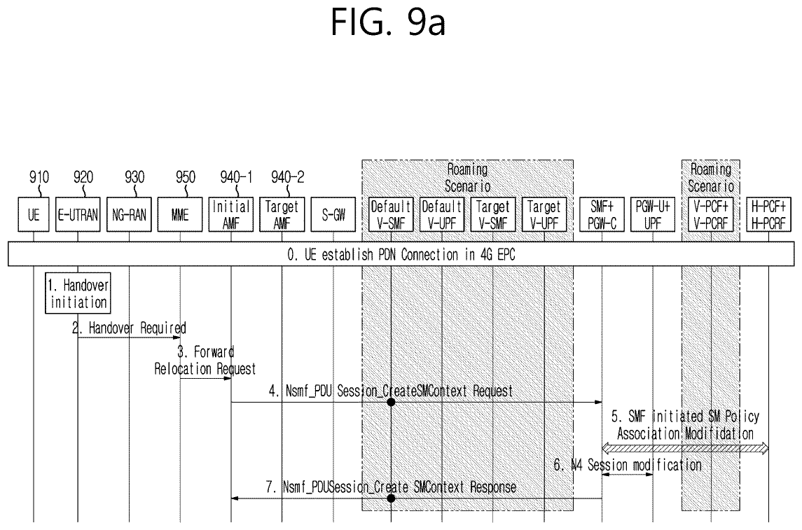

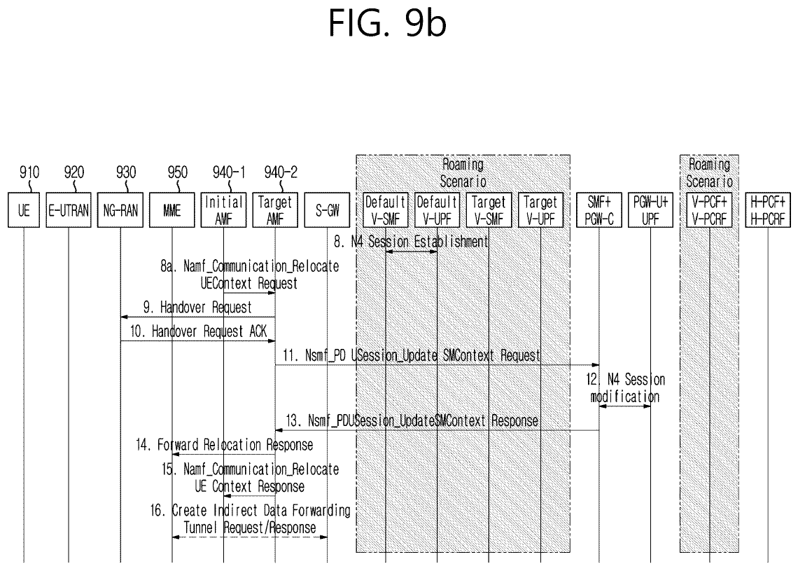

FIGS. 9a and 9b illustrate an example of mobility-related procedures from EPS to 5GS according to an embodiment of the present disclosure. The procedures of FIGS. 9a and 9b may basically follow the handover procedure from EPS to 5GS using the N26 interface of clause 4.11.1.2.2 of TS 23.502. For example, the remaining steps except step 9 below in the procedures of FIGS. 9a and 9b may follow the handover procedure from EPS to 5GS using the N26 interface of clause 4.11.1.2.2 of TS 23.502.

Referring to FIGS. 9a and 9b, in step 9, the target AMF 910-2 transmits a handover request message including an allowed CAG list to NG-RAN 930. The target AMF 940-2 may check whether UE subscription data is stored in the target AMF 940-2. If UE subscription data is stored, the target AMF 940-2 may obtain an allowed CAG list from the UE subscription data and may transmit a handover request message including the obtained CAG list to NG-RAN 930. NG-RAN 930 may apply or enforce CAG based on the allowed CAG list. On the other hand, if UE subscription data is not stored in the target AMF 940-2, the target AMF 940-2 may retrieve UE subscription data from UDM and may include the allowed CAG list within the retrieved UE subscription data in the handover request message to transmit to NG-RAN 930.

UE subscription data may be obtained from UDM by the initial AMF 940-1 rather than the target AMF 940-2. In this case, the remaining steps except the steps described below in the procedures of FIGS. 9a and 9b may follow the handover procedure from EPS to 5GS using the N26 interface of clause 4.11.1.2.2 of TS 23.502. For example, before the target AMF 940-2 transmits the handover request message in step 9, the initial AMF 940-1 may retrieve UE subscription data from UDM after step 3 or after step 7. For example, after receiving the forward relocation request message, the initial AMF 940-1 may obtain UE subscription data from UDM in parallel while performing steps 4 to 7. If the initial AMF 940-1 possessed UE subscription data or obtained UE subscription data from UDM, the initial AMF 940-1 may transmit a message including allowed CAG information (e.g., allowed CAG list) based on UE subscription data to the target AMF 940-2 in step 8a. The message including allowed CAG information may include a Namf_Communication_RelocateUEContext Request message. According to one embodiment, when a CSG list is included in the forward relocation request message received from MME 950 or when the target cell is a CAG cell, the initial AMF 940-1 may obtain UE subscription data from UDM. When allowed CAG information is received from the initial AMF 940-1, the target AMF 940-2 may transmit a handover request message including the allowed CAG information to NG-RAN 930 in step 9.

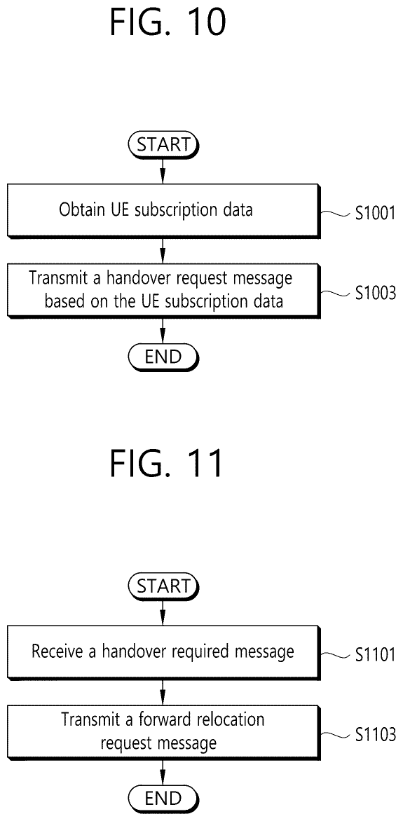

FIG. 10 illustrates an example of a procedure for transmitting allowed CAG information according to an embodiment of the present disclosure. FIG. 10 exemplifies a method performed by an AMF. FIG. 10 may be performed when handover from EPS to 5GS occurs.

Referring to FIG. 10, in step S1001, the AMF obtains subscription data of the terminal. The subscription data of the terminal may include an allowed CAG list indicating IDs of CAG cells for which the terminal's use is allowed. The AMF, as a target AMF that manages or controls the handover target cell of the terminal, obtains subscription data of the terminal that requires handover. According to one embodiment, when a message related to relocate UE context request for handover of the terminal (e.g., Namf_Communication_RelocateUEContext Request) is received from the initial AMF, the target AMF may check whether subscription data of the corresponding terminal is stored in the target AMF. If subscription data of the corresponding terminal is not stored within the target AMF, the target AMF may search and obtain the terminal's subscription data from UDM. According to one embodiment, the target AMF may receive the terminal's subscription data from the initial AMF. For example, when the initial AMF receives a forward relocation request message from MME and it is confirmed that a CSG list is included in the received forward relocation request message or the target cell is a CAG cell, it may retrieve and obtain the terminal's subscription data from UDM, and may transmit a message related to relocate UE context request including the obtained terminal's subscription data to the target AMF.

In step S1003, the AMF transmits a handover request message based on the terminal's subscription data. The AMF obtains an allowed CAG list included in the terminal's subscription data and transmits a handover request message including the allowed CAG list to NG-RAN. At this time, NG-RAN may apply CAG to the terminal based on the allowed CAG list included in the handover request message.

FIG. 11 illustrates an example of a procedure for transmitting CSG-related information according to an embodiment of the present disclosure. FIG. 11 exemplifies a method performed by a first network node of a first system. FIG. 11 may be performed when handover from a first system to a second system occurs. For example, the first system may be a 5GS system and the second system may be an EPS system. The first network node may include an AMF.

Referring to FIG. 11, in step S1101, the first network node receives a handover required message. When a terminal should be handed over from a base station of the first system to a base station of the second system, the first network node may receive a handover required message from the base station of the first system. According to one embodiment, the handover required message may include at least one of identification information of the target base station (e.g., eNB ID) or target cell identification information (e.g., target cell ID). According to one embodiment, it may include at least one of a second group ID related to access of the target cell or cell access mode information indicating whether the target cell is in hybrid mode. The second group may be a group for restricting user access in the second system and may include a CSG group.

In step S1103, the first network node transmits a forward relocation request message. The first network node may transmit a forward relocation request message to a second network node of the second system for data path reconfiguration and/or terminal context transfer. The first network node may transmit a forward relocation request message to the second network node of the second system based on the handover required message. For example, when the target cell is identified as a second group cell based on the handover required message, the first network node may transmit a forward relocation request message including at least one of the second group ID of the target cell (e.g., CSG ID) or second group member indication information (e.g., CSG group membership indication) indicating whether the corresponding terminal belongs to the second group to the second network node of the second system. The forward relocation request message may further include identification information of the target base station managing the target cell.

According to one embodiment, the first network node may determine whether the target cell is a second group cell of the second system based on information configured in the first network node and information included in the handover required message. The first network node may determine that the target cell is a second group cell based on information related to the second group pre-configured in the first network node. The information related to the second group may include at least one of ID of candidate base stations of the second system capable of handover, cell ID of the corresponding candidate base station, TAI of the corresponding cell, or mapping information of the second group and first group. The first group may be a group for restricting user access in the first system and may include CAG. The mapping information of the second group and first group may include at least one of the second group ID and first group ID mapped to the second group ID, or cell access mode of the second group cell. The cell access mode of the second group cell may indicate whether the second group cell is a hybrid cell. For example, the first network node may determine whether the target cell is a second group cell based on whether identification information of the target base station or target cell identification information included in the handover required message is included in information related to the second group pre-configured in the first network node. When the target cell is determined to be a second group cell, the first network node may transmit a forward relocation request message to the second network node of the second system.

According to one embodiment, the first network node may confirm from the handover required message that the handover target cell of the terminal is a second group cell of the second system. Subsequently, the first network node may check whether the target cell is a cell allowed for the terminal based on the second group ID of the target cell and subscriber information of the terminal. When the target cell is a cell allowed for the terminal, the first network node may transmit a forward relocation request message to the second network node of the second system.

According to one embodiment, the first network node may further perform at least one operation of the AMF 540 of FIGS. 5a and 5b, the AMF 640 of FIGS. 6a and 6b, the AMF of FIG. 7, or the AMF of FIG. 8.

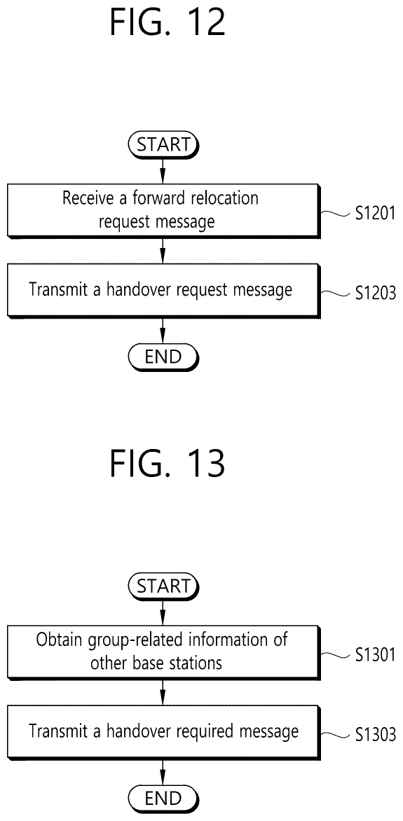

FIG. 12 illustrates an example of a procedure for receiving CSG-related information according to an embodiment of the present disclosure. FIG. 12 exemplifies a method performed by a second network node of a second system. FIG. 12 may be performed when handover from a first system to a second system occurs. For example, the first system may be a 5GS system and the second system may be an EPS system. The second network node may include an MME.

Referring to FIG. 12, in step S1201, the second network node receives a forward relocation request message. The second network node of the second system may receive a forward relocation request message from a first network of the first system. The forward relocation request message may include at least one of a second group ID indicating that the handover target cell of the terminal is a second group cell of the second system, or second group member indication information (e.g., CSG group membership indication) indicating whether the corresponding terminal belongs to the second group. The forward relocation request message may further include identification information of the target base station managing the target cell. Here, the second group may be a group for restricting user access in the second system and may include a CSG group.

In step S1203, the second network node transmits a handover request message. The second network node may identify the target base station based on the forward relocation request message and transmit a handover request message to the target base station. The handover request transmission message may include at least one of the second group ID received through the forward relocation request message or second group member indication information indicating whether the corresponding terminal belongs to the second group.

According to one embodiment, the second network node may further perform at least one operation of the MME 550 of FIGS. 5a and 5b, the MME 650 of FIGS. 6a and 6b, or the MME of FIG. 8.

FIG. 13 illustrates an example of transmitting CSG-related information according to an embodiment of the present disclosure. FIG. 13 exemplifies a method performed by a base station of a first system. FIG. 13 may be performed when handover from a first system to a second system occurs. For example, the first system may be a 5GS system and the second system may be an EPS system. The base station may include a source gNB.

Referring to FIG. 13, in step S1301, the base station obtains group-related information related to access of each cell from at least one other base station. The base station may recognize at least one other base station located in the vicinity based on ANR and exchange group-related information related to access of each cell with the recognized at least one other base station using configuration transfer signaling. For example, the base station may transmit group-related information related to access of at least one cell that it supports to at least one other base station using configuration transfer signaling, and receive group-related information related to access of at least one other cell supported by the corresponding base station from at least one other base station using configuration transfer signaling. The group-related information may include at least one of information related to a first group (e.g., CAG) of the first system or information related to a second group (e.g., CSG) of the second system. The information related to the first group may include a first group list containing first group identification information (e.g., CAG ID) supported by the corresponding base station (e.g., gNB). The information related to the second group may include at least one of a second group list containing second group identification information (e.g., CSG ID) supported by the corresponding base station (e.g., eNB) or cell access mode of cells corresponding to each second group identification information.

In step S1303, the base station transmits a handover required message for the terminal. The base station may detect that handover of the terminal is required and check whether the target cell is a second group cell of the second system using identification information of the terminal's handover target cell and group-related information related to access of each cell supported by at least one other base station. When the target cell is a second group cell of the second system, the base station may transmit a handover required message including at least one of second group identification information of the target cell or cell access mode indicating whether the target cell is a hybrid cell to the first network node of the first system.

According to one embodiment, the base station may further perform at least one operation of the source gNB 830 of FIG. 8.

Examples of the proposed methods described above can also be included as one of the implementation methods of the present disclosure, so it is clear that they can be considered as types of proposed methods. In addition, the proposed methods described above may be implemented independently, but may also be implemented in the form of a combination (or merger) of some proposed methods. Rules may be defined so that information on whether the proposed methods are applied (or information on the rules of the proposed methods) is notified by the base station to the terminal through a predefined signal (e.g., physical layer signal or higher layer signal).

The present disclosure may be embodied in other specific forms without departing from the technical ideas and essential features described in the present disclosure. Therefore, the above detailed description should not be interpreted as restrictive in all aspects but should be considered as illustrative. The scope of the present disclosure should be determined by reasonable interpretation of the appended claims, and all changes within the equivalent scope of the present disclosure are included in the scope of the present disclosure. In addition, claims that do not have explicit citation relationships in the claims may be combined to form embodiments or may be included as new claims by amendments after filing.

The embodiments of the present disclosure can be applied to various wireless access systems. Examples of various wireless access systems include 3rd Generation Partnership Project (3GPP) or 3GPP2 systems.

The embodiments of the present disclosure can be applied not only to the various wireless access systems described above, but also to all technical fields that apply the various wireless access systems. Furthermore, the proposed method can also be applied to mm Wave and THz communication systems that use ultra-high frequency bands.

Additionally, the embodiments of the present disclosure can also be applied to various applications such as autonomous vehicles and drones.

1. A method comprising:
receiving, by a first network node of a first system, a handover required message for a terminal from a source base station; and
transmitting, by the first network node, a forward relocation request message to a second network node of a second system based on the handover required message,
wherein the forward relocation request message includes at least one of identification information of a second group related to access of a target cell, or information informing whether the terminal belongs to the second group.

2. The method of claim 1, wherein transmitting of the forward relocation request message comprises, determining, by the first network node of the first system, whether a handover target cell is a second group cell of the second system based on information configured in the first network node and the handover required message,
wherein the forward relocation request message is transmitted based on the target cell being the second group cell of the second system.

3. The method of claim 2, wherein the information configured in the first network node includes at least one of an ID of a candidate base station of the second system capable of handover, a cell ID of the candidate base station, tracking area identity (TAI) of a cell, or mapping information of the second group of the second system and a first group of the first system, and
wherein the mapping information includes at least one of a second group ID and a first group ID mapped to the second group ID, or cell access mode informing whether the second group cell is a hybrid cell.

4. The method of claim 3, wherein whether the handover target cell is the second group cell of the second system is determined based on whether at least one of an ID of a target base station or an ID of a target cell included in the handover required message is included in the information configured in the first network node.

5. The method of claim 3, wherein transmitting of the forward relocation request message further comprises, determining whether the target cell is a cell allowed for the terminal based on the second group ID of the target cell and subscriber information of the terminal when the target cell is the second group cell of the second system,
wherein, when the target cell is the cell allowed for the terminal, the forward relocation request message is transmitted, and
wherein, when the target cell is not the cell allowed for the terminal, a handover preparation failure message is transmitted from the first network node to the source base station.

6. The method of claim 3, wherein transmitting of the forward relocation request message further comprises, determining whether the target cell is the hybrid cell based on the cell access mode of the target cell when the target cell is the second group cell of the second system,
wherein the information informing whether the terminal belongs to the second group is included in the forward relocation request message based on the target cell being the hybrid cell.

7. The method of claim 2, wherein the first group includes a closed access group (CAG), and
the second group includes a closed subscriber group (CSG).

8. The method of claim 1, wherein the handover required message includes at least one of second group identification information of the target cell, or cell access mode informing whether the target cell is a hybrid cell.

9. (canceled)

10. A method comprising:
obtaining, by a first base station of a first system, information related to a second group from a second base station of a second system; and
transmitting, by the first base station, a handover required message for a terminal to a first network node,
wherein the handover required message includes at least one of second group identification information related to access of a handover target cell of the terminal, or cell access mode informing whether the target cell is a hybrid cell.

11. The method of claim 10, wherein the information related to the second group is obtained through a configuration transfer signaling with the second base station, and
the information related to the second group includes at least one of a group list of at least one cell supported by the second base station, or cell access mode information of the at least one cell.

12. An apparatus comprising:
a transceiver; and
a processor connected to the transceiver, wherein the processor controls to:
receive a handover required message for a terminal from a source base station of a first system to which the apparatus belongs, and
transmit a forward relocation request message to a second network node of a second system based on the handover required message,
wherein the forward relocation request message includes at least one of second group identification information related to access of a target cell, or information informing whether the terminal belongs to the second group.

13-16. (canceled)
